(19) United States
(12) Patent Application Publication
(10) Pub. No.: US 2017/0239866 A1
(43) Pub. Date: Aug. 24, 2017

(54) ADDITIVE MANUFACTURING COMPOSITION, METHOD AND SYSTEM

(71) Applicant: Caterpillar Inc., Peoria, IL (US)

(72) Inventors: Khaled M. Mohammad, Tremont, IL (US); Eric Edward Halla, Peoria, IL (US); Jay H. Cline, Hopewell, IL (US); Christopher Michael Arrick, Washington, IL (US); Travis James King, Columbia, MO (US)

(73) Assignee: Caterpillar Inc., Peoria, IL (US)

(21) Appl. No.: 15/051,953

(22) Filed: Feb. 24, 2016

(51) Int. Cl. B29C 47/00; C08L 15/02

(52) U.S. Cl. CPC B29C 47/0004; C08L 15/02; B29K 2021/00

(57) ABSTRACT

A composition for additive manufacturing is provided. The composition comprises a solvent and a rubber dissolved in the solvent, wherein the ratio of rubber to solvent is in a range of 1:10 to 3:5. A method of manufacturing an object is also provided. The method includes forming a first layer of the object by dispensing a printable composition comprising rubber dissolved in a solvent, in a ratio of 1:10 to 3:5 allowing at least a portion of the solvent in the first layer to evaporate, adding a second layer to the first layer by dispending a printable composition comprising a rubber dissolved in a solvent in a ratio of 1:10 to 3:5 and allowing at least a portion of the solvent in the second layer to evaporate.

### TECHNICAL FIELD

Present disclosure relates to additive manufacturing. In particular, present disclosure relates to a composition, method and system for additive manufacturing.

### BACKGROUND

Additive manufacturing or 3D printing is a process in which 3-dimensional objects are created from a digital model. A digital model of the object is generated using known digital modeling methods, such as using Computer Aided Design (CAD) programs. The digital model is divided into units in which each unit indicates where the material should be located in a layer. The individual units are sent to an additive manufacturing system or 3D printer which deposits the material according to the individual units and generates the complete three-dimensional object layer by layer.

Various materials such as plastic materials, resins and metals are currently available for use in additive manufacturing processes. One such composition is disclosed in Chinese Patent application number CN103992560. This document discloses a polypropylene polyphase copolymer resin for 3D printing.

However, compositions that allow for additive manufacturing of rubber objects are not available.

### SUMMARY OF THE INVENTION

In an aspect of the present disclosure, a composition for additive manufacturing is disclosed. The composition includes a solvent and a rubber dissolved in the solvent. The ratio of rubber to solvent is in a range of 1:10 to 3:5.

In yet another aspect a method of manufacturing an object is disclosed. The method includes forming a first layer of the object by dispensing a printable composition comprising a rubber dissolved in a solvent wherein the ratio of rubber to solvent is in a range of 1:10 to 3:5 and allowing at least a portion of the solvent in the first layer to evaporate. The method further includes adding a second layer to the first layer by dispensing a printable composition comprising a rubber dissolved in a solvent wherein the ratio of rubber to solvent is in a range of 1:10 to 3:5 and allowing at least a portion of the solvent in the second layer to evaporate.

In yet another aspect an additive manufacturing system for manufacturing an object is disclosed. The additive manufacturing system includes a platform, a dispenser for dispensing a printable composition in layers on to the platform, the printable composition comprising a rubber dissolved in a solvent, wherein the ratio of rubber to solvent in the printable composition in a range of 1:10 to 3:5 and the dispenser is configured to dispense a second layer of the printable composition after at least a portion of the solvent is evaporated from the first layer. The additive manufacturing system further includes a heater configured to facilitate evaporation of at least a portion of the solvent from the first layer before the dispenser dispenses the second layer of the printable composition.

### BRIEF DESCRIPTION OF THE DRAWINGS

FIG. 1 illustrates an additive manufacturing system in accordance with an embodiment.

FIG. 2 illustrates an additive manufacturing system in accordance with an embodiment.

FIG. 3 illustrates an additive manufacturing system in accordance with an embodiment.

FIG. 4 illustrates a method of manufacturing an object using additive manufacturing process in accordance with an embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

The present disclosure provides a composition for additive manufacturing. The composition includes a solvent and a rubber dissolved in the solvent. In one embodiment, the ratio of the rubber to solvent may be in a range of about 1:10 to 3:5. In another embodiment, the ratio of the rubber to solvent may be in a range of about 1:5 to 3:5. In yet another embodiment, the ratio of the rubber to solvent may be approximately 0.53.

The rubber may be selected from the group consisting of fluorocarbon rubber (FKM), acrylonitrile-butadiene rubber (NBR), hydrogenated acrylonitrile-butadiene rubber (HNBR), chloroprene rubber (CR), silicone rubber (VMQ), fluorosilicone rubber (FVMQ), polyacrylate rubber (ACM), ethylene acrylic rubber (AEM), styrene-butadiene rubber (SBR), and natural rubber (NR).

The fluorocarbon rubber (FKM) may be selected from a group consisting of vinylidene fluoride-hexafluoropropylene rubber (VDF-HFP), tetrafluoroethylene-propylene rubber, tetrafluoroethylene perfluoromethyl vinyl ether rubber, and vinylidene fluoride-hexafluoropropylene-tetrafluoroethylene (VDF-HFP-TFE) rubber.

In an embodiment, the composition may include a fluorocarbon rubber (FKM) and a methyl ethyl ketone solvent.

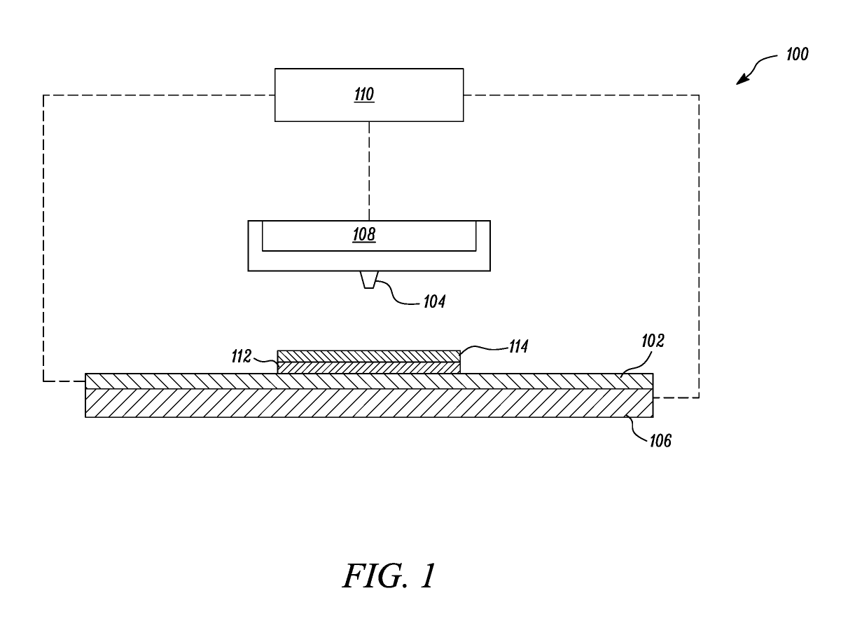

As illustrated in FIG. 1, the present disclosure also provides for an additive manufacturing system 100 configured to dispense a printable composition. The printable composition may be a composition including a rubber dissolved in a solvent, as described above. The additive manufacturing system 100 may include a platform 102, a dispenser 104 and a heater 106.

The dispenser 104 is configured to dispense the printable composition in layers on the platform 102. The dispenser 104 is further configured to dispense a second layer 114 of the printable composition after at least a portion of the solvent is evaporated from the first layer 112. The dispenser 104 is configured to dispense a second layer 114 of the printable composition after about 80 percent to 90 percent of the solvent has evaporated from the first layer 112. The dispenser 104 may further be connected to a reservoir 108 for holding the printable composition.

The heater 106 is configured to facilitate evaporation of at least a portion of the solvent from the layer 112 before the dispenser 104 dispenses the second layer 114 of the printable composition. The heater may facilitate evaporation of the solvent by creating a heated environment that increases the rate of evaporation. In certain embodiments, the heater 106 may be coupled to the platform 102 and configured to heat the platform 102 through.

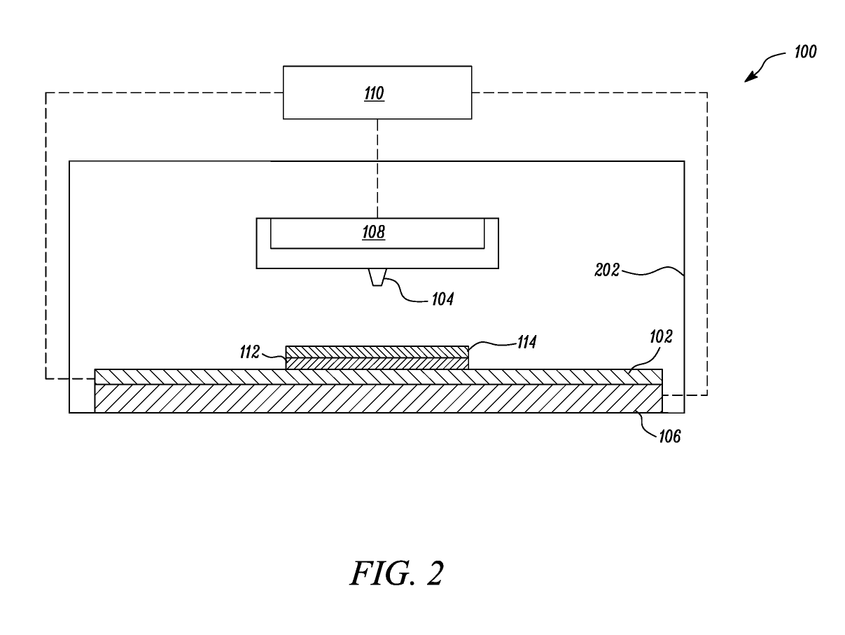

In an alternate embodiment, the additive manufacturing system 100 further includes a housing 202 for the platform 102 as illustrated in FIG. 2. In such embodiments, the heater 106 may be coupled to the housing 202 in addition to or in lieu of the platform 102. The heater 106 may alternatively be positioned within the housing 202. The heater 106 is configured to heat the atmosphere within the housing 202. In another embodiment the heater 106 may be positioned outside the housing 202 and configured to provide heated air or other gases to the housing 202. In such a case a blower may be used to provide heated air or gases to the housing 202, to heat the atmosphere within the housing.

The heater 106 may be any known type of heating system, including, but not limited to an electric heater, gas based heater, oil based heater, heat exchanger etc.

In embodiments in which the additive manufacturing system 100 includes a housing 202, the additive manufacturing system 100 may further include a solvent collection system configured to collect the evaporated solvent. The solvent collection system may comprise of a vapor inlet in communication with the housing 202 for receiving the evaporated solvent present in the housing 202, a heat exchanger for condensing the evaporated solvent and a collection chamber for receiving the condensed solvent. Though one type of collection system has been provided, other types of collection systems may also be contemplated.

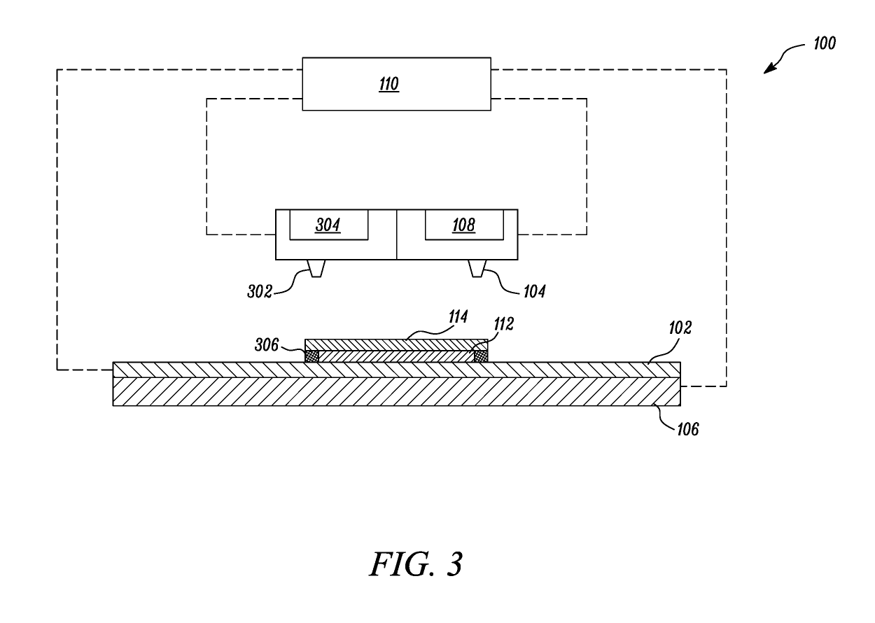

In accordance with an embodiment, the additive manufacturing system 100 may further include a second dispenser 302 for dispensing a support material composition as illustrated in FIG. 3. The second dispenser 302 is configured to dispense the support material composition as a support material layer 306. The second dispenser 302 may be connected to a second reservoir 304 for holding the support material composition.

In yet another embodiment, the dispenser 104 may be configured to dispense both the printable composition and the support material composition. In such embodiments the dispenser 104 may be connected to two separate reservoirs: one containing the printable composition and the other containing the support material composition.

The dispenser 104 and the platform 102 are configured to move relative to each other. In an embodiment, the platform 102 is stationary while the dispenser 104 is configured to move relative to the platform 102 along one or more axis. In an alternate embodiment, the dispenser 104 is stationary while the platform 102 is configured to move relative to the disperser 104 along one or more axis. In yet another embodiment, the dispenser 104 and the platform 102 are both configured to move relative to each other along one or more axis. In a similar manner, the second dispenser 302 and the platform 102 are also configured to move relative to each other along one or more axis.

The additive manufacturing system 100 may further include a controller 110. The controller 110 is configured to control the dispenser 104, the platform 102 and the heater 106. The controller 110 may control the dispenser 104 such that the dispenser 104 dispenses the printable composition in layers on to the platform 102, in a manner that the second layer 114 of the printable composition is dispensed after at least a portion of the solvent has evaporated from the first layer 112. The controller 110 may control the dispenser 104 such that the dispenser 104 dispenses the printable composition in a manner that the second layer 114 of the printable composition is dispensed after about 80 percent to 90 percent of the solvent has evaporated from the first layer 112. The controller 110 may also control the dispenser 104 such that the dispenser 104 dispenses the printable composition on a desired position or location. The controller 110 may also control the thickness of each layer by selectively adjusting the output from the dispenser 104. The controller 110 may also be configured to control the movement of the dispenser 104 and the platform 102 relative to each other. Further the controller 110 is also configured to control the temperature of the heater 106, so that the platform 102 and/or the atmosphere within the housing 202 is maintained at a desired temperature. The controller 110 is configured to control the temperature of the heater 106 to about seventy degree Celsius to about 150 degree Celsius.

In an embodiment, the controller 110 may include a processor. The processor (and/or co-processors or any other processing circuitry assisting or otherwise associated with the processor) may be in communication with a Computer Aided Design (CAD) system. The processor may be embodied in a number of different ways. For example, the processor may be embodied as one or more of various hardware processing means such as a co-processor, a microprocessor, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like.

### INDUSTRIAL APPLICABILITY

The present disclosure discloses a composition for additive manufacturing. The composition may include a rubber dissolved in a solvent in a ratio of about 1:10 to 3:5. The composition as disclosed allows for the formation of rubber objects using additive manufacturing.

In yet another aspect, the present disclosure discloses an additive manufacturing system 100. The additive manufacturing system 100 as disclosed may include a platform 102, a dispenser 104 and a heater 106. The dispenser 104 is configured to dispense the printable composition in layers on to the platform 102 in a manner that a second layer 114 of the printable composition is dispensed after at least a portion of the solvent is evaporated from the first layer 112. The additive manufacturing system 100 as disclosed allows for the formation of rubber objects by additive manufacturing.

In yet another aspect of the present disclosure, the additive manufacturing system 100 includes a second dispenser 302. The second dispenser 302 is configured to dispense a support material composition for forming a support structure. This allows for building of objects having features such as overhangs and undercuts which are supported by the support structure formed by the dispensed support material composition during fabrication.

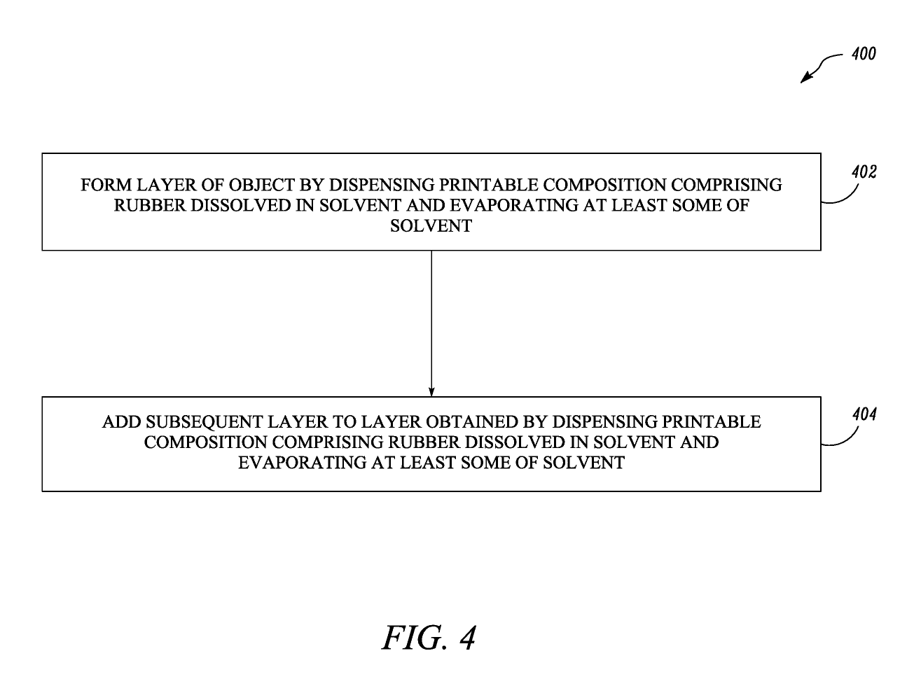

In yet another aspect of the present disclosure, a method 400 of manufacturing an object using additive manufacturing is provided. Referring to FIG. 4 the method includes the following steps. At step 402 a first layer of the object is formed by dispensing a printable composition comprising a rubber dissolved in a solvent. The solvent in the first layer formed in step 402 is then allowed to evaporate for a period of time in step 404. About 80 percent to about 90 percent of the solvent is allowed to evaporate from the first layer in step 404. At step 406 a second layer is added to the layer obtained in step 402 by dispensing a printable composition comprising a rubber dissolved in a solvent onto the layer obtained in step 404. The solvent in the second layer of printable composition formed in step 406 is then allowed to evaporate for a period of time at step 408. About 80 percent to about 90 percent of the solvent is allowed to evaporate from the second layer in step 408. In an aspect, the ratio of rubber and solvent in the printable composition is in a ratio of 1:10 to 3:5. In an embodiment, the ratio of the rubber to solvent may be approximately 0.53. As will be appreciated by those skilled in the art, any number of layers may be formed sequentially until a desired product shape has been created.

In an embodiment, the dispensed printable composition is heated to initiate curing of rubber. The first layer is partially cured before addition of the second layer. In accordance with an aspect, about 15 seconds are allowed before addition of subsequent layer to allow for partial curing of the layer. The term “curing” refers to the reactive process that occurs after evaporation of solvent from the layer obtained by dispensing the printable composition. The term “partial curing” is intended to imply that at least a portion of the solvent has evaporated from the layer obtained by dispensing the printable composition. In an embodiment “partial curing” is intended to imply that about 80 percent to about 90 percent of the solvent has evaporated from the layer obtained by dispensing the printable composition. Partial curing of the first layer before addition of the second layer allows better bonding of rubber between the layers.

In an embodiment, the rubber is a fluorocarbon rubber. In an embodiment, the solvent is methyl ethyl ketone. The ratio of fluorocarbon rubber to solvent may be approximately 0.53. By way of an example, 8 grams of fluorocarbon rubber is dissolved in 15 grams of methyl ethyl ketone.

Where the rubber is fluorocarbon rubber and the solvent is methyl ethyl ketone, the dispensed printable composition may be heated to about seventy degree Celsius to about 150 degree Celsius during and following the step of dispensing to initiate curing of the rubber.

In an embodiment, the method further includes post curing the fabricated object. The object may be post cured by accelerating evaporation of substantially all the solvent from the object once the object is completely formed. In one embodiment, the post curing may take place by allowing the object to stand at an ambient temperature to substantially evaporate all of the solvent from the object. In an alternate embodiment, the post curing can be carried out by heating the object to substantially evaporate all of the solvent from the object.

The method may further comprise dispensing a support material composition. Dispensing the support material composition allows for the formation of a support structure. The support structure allows fabrication of objects that have features such as overhangs and undercuts. In accordance with an aspect, the support structure is removed once the object is fabricated. The support structure may be removed before or after post curing of the object.

The support material composition is selected from a wax, polymer, pre-polymer, UV curable polymer, and mixtures thereof.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A composition for additive manufacturing comprising a solvent and a rubber dissolved in the solvent, wherein the ratio of rubber to solvent is in a range of 1:10 to 3:5.

2. The composition of claim 1, wherein the rubber is selected from a group consisting of fluorocarbon rubber (FKM), acrylonitrile-butadiene rubber (NBR), hydrogenated acrylonitrile-butadiene rubber (HNBR), chloroprene rubber (CR), silicone rubber (VMQ), fluorosilicone rubber (FVMQ), polyacrylate rubber (ACM), ethylene acrylic rubber (AEM), styrene-butadiene rubber (SBR), and natural rubber (NR).

3. The composition of claim 2, wherein the fluorocarbon rubber is selected from a group consisting of vinylidene fluoride-hexafluoropropylene rubber (VDF-HFP), tetrafluoroethylene-propylene rubber, tetrafluoroethylene perfluoromethyl vinyl ether rubber, and vinylidene fluoride-hexafluoropropylene-tetrafluoroethylene (VDF-HFP-TFE) rubber.

4. The composition of claim 3, wherein the solvent is methyl ethyl ketone.

5. The composition of claim 4, wherein the ratio of fluorocarbon rubber to methyl ethyl ketone is approximately 0.53.

6. A method of manufacturing an object comprising:
forming a first layer of the object by dispensing a printable composition comprising a rubber dissolved in a solvent;
allowing at least a portion of the solvent in the first layer to evaporate;
adding a second layer to the first layer by dispensing a printable composition comprising a rubber dissolved in a solvent;
allowing at least a portion of the solvent in the second layer to evaporate;
wherein the ratio of rubber to solvent is in a range of 1:10 to 3:5.

7. The method of claim 6, wherein the rubber is a fluorocarbon rubber.

8. The method of claim 7, wherein the solvent is methyl ethyl ketone.

9. The method of claim 8, wherein the ratio of fluorocarbon rubber to methyl ethyl ketone is approximately 0.53.

10. The method of claim 6, wherein the dispensed printable composition is heated about seventy degree Celsius to about 150 degree Celsius to initiate curing of the rubber.

11. The method of claim 6, wherein about 80 percent to 90 percent solvent is allowed to evaporate from the first layer and the second layer.

12. The method as claimed in claim 6, wherein the first layer is partially cured before addition of the second layer.

13. The method as claimed in claim 6, further comprising post curing the object by evaporating substantially all the solvent from the object.

14. The method as claimed in claim 6, further comprising dispensing a support material composition for providing a support structure.

15. The method as claimed in claim 14, wherein the support material composition is selected from a wax, polymer, pre-polymer, UV curable polymer and mixture thereof.

16. An additive manufacturing system for manufacturing an object, the additive manufacturing system comprising:
a platform;
a dispenser for dispensing a printable composition in layers on to the platform, the printable composition comprising a rubber dissolved in a solvent, wherein the ratio of rubber to solvent is in a range of 1:10 to 3:5 and the dispenser configured to dispense a second layer of the printable composition only after at least a portion of the solvent is evaporated from a first layer; and
a heater configured to facilitate evaporation of at least a portion of the solvent from the first layer before the dispenser dispenses the second layer of the printable composition.

17. The additive manufacturing system as claimed in claim 16, wherein the heater is coupled to the platform for heating the platform.

18. The additive manufacturing system as claimed in claim 16, further comprising a housing for the platform wherein the heater is configured to heat the atmosphere within the housing.

19. The additive manufacturing system as claimed in claim 16, further comprising a second dispenser for dispensing a support material composition.

20. The additive manufacturing system as claimed in claim 16, wherein the dispenser and the platform are configured to move relative to each other along one or more axis.
